(19) United States
(12) Patent Application Publication
(10) Pub. No.: US 2016/0365985 A1
(43) Pub. Date: Dec. 15, 2016

(54) METHOD AND SYSTEM FOR RECURSIVELY EMBEDDED CERTIFICATE RENEWAL AND REVOCATION

(71) Applicants: Jared Pilcher, Lehi, UT (US); Jason Sabin, Lehi, UT (US)

(72) Inventors: Jared Pilcher, Lehi, UT (US); Jason Sabin, Lehi, UT (US)

(21) Appl. No.: 14/736,411

(22) Filed: Jun. 11, 2015

(51) Int. Cl. H04L 9/32; H04L 9/08

(52) U.S. Cl. CPC H04L 9/3268; H04L 9/0819

(57) ABSTRACT

A method and system are disclosed for renewing and revoking certificates. In one embodiment, a certificate may include a renewal extension field with renewal information. Multiple sets of renewal information may be recursively embedded. Upon determining that a certificate will shortly expire, a server may determine that the certificate has a renewal extension field with renewal information, and may request a symmetric key from a certificate authority to decrypt the renewal information. The certificate authority may respond by providing a symmetric key, and the server may use the symmetric key to decrypt the renewal information, which may include updated field values for the certificate. If a server requests a symmetric key too early, i.e., too long before a certificate expires, then certificate authority may deny the request, and the server may determine to wait and then try requesting the symmetric key again. In another embodiment, a certificate authority may revoke a certificate by providing a short lifespan and not providing a symmetric key to decrypt the renewal information.

### BACKGROUND

Digital Certificates (“certificates”) are critical to Internet security. Certificates are electronic files that make it possible for information to be transferred privately over the Internet. Such information may include personal identifying information, individually identifiable health information, proprietary information, and confidential information. Certificates provide peace of mind to Internet users by verifying the identity of the destination to which a user is sending sensitive or confidential information.

Certificates are issued by Certificate Authorities (“CA” s), or by trusted intermediaries of CAs. As used herein, “CA” may also refer to an intermediary of a CA. An intermediary CA of a root CA is trusted and operated by the root CA, and issues certificates on behalf of the root CA. A CA issues a certificate, encrypted with the CA's private key, to a requesting server after the CA has taken measures to verify the identity of the server or administrator(s) of the server. A server may be a website, website operator, or any other service or network entity desiring to provide some level of assurance of its identity.

When an Internet user visits a website or other resource or location administered by a server, the website presents its certificates to the user to verify its identity to the visiting Internet user. When presented with a certificate, an Internet user, generally through a browser such as Internet Explorer, Chrome, or Firefox, consults its list of trusted CAs. If this list of trusted CAs includes the CA that issued the certificate, then the Internet user will attempt to decrypt the certificate with the CA's public key. If the certificate decrypts properly, then the Internet user will generally believe the information in the certificate, i.e., the Internet user will believe that the website is operated by the entity identified in the certificate.

The term “Internet user” is exemplary. Many different types of entities, for many different reasons, may rely on digital certificates for security or for some other reasons.

Certificates often operate in a time-based paradigm or model, under which a certificate is not perpetually valid, but instead has an expiration after which it is no longer valid. In addition to becoming invalid through expiration, a certificate may become invalid through revocation. A CA may revoke a certificate for multiple reasons, including but not limited to a determination that a particular URL or Internet or network resource is no longer administered by a particular entity, or that the server providing a certificate has been compromised, or that a particular certificate has been compromised, or that there is a need to issue an updated certificate, or any other reason well-known in the art. In many digital certificate systems, when a certificate expires, it must be renewed.

Certificate renewal and revocation is a well-known, and wide-sweeping issue in network security. Current protocols and approaches for certificate renewal and revocation are often complex and difficult to build and use. Some common clients, such as Chrome, almost completely ignore revoked certificates because of the poor performance of revocation protocols and approaches.

Certificate renewals may happen at regular intervals when a certificate expires. The process to reinstall the certificate often requires special expertise, requiring many man hours to perform. Current schemes and protocols used to ease the burden of installation and configuration are often bulky and difficult to build, and can therefore be especially error-prone. Such circumstances may result in weakening of the overall security of the network.

At times, intermediate and root certificates (in addition to ordinary certificates) need to be revoked. Current revocation schemes cannot adequately address this issue without performance degradation. Since root certificates are often cached in many clients and servers, revoking a root certificate is almost impossible. If a CA does not comply with standard validation practices, removing or revoking a root certificate from the trusted certificate root store in every device can take years to complete.

Current implementations of certificate revocations are often ignored because of their poor performance. The Certificate Revocation List (CRL) scheme, for example, encourages a client to retrieve a list of certificate revocations from a Certificate Authority (CA) during each transport-layer-security (TLS) handshake. The list can become large over time as more certificate revocations are added. Downloading the list often uses a substantial amount of resources including network bandwidth, power, and quality of service. Moreover, with many clients retrieving the CRL from the CA, this scheme can become a bottleneck for TLS connections.

Previous efforts to solve the issue of certificate revocation include short-term certificates and OCSP stapling. Short-term certificates utilize short time periods for which the certificate is active. Since the certificate expires quickly, the CA can simply deny the certificate renewal, making revocation trivial. OCSP stapling is a protocol requiring the server to request a signed message from the CA that the organization in control of the server is still in good standing. The server sends this message to a client, which can verify that the message is valid.

Another problem is that certificates sometimes expire without the server administrator's knowledge, causing service outages. If these certificates are associated with critical services, the consequences for a company may be disastrous.

It would be beneficial to CAs, servers, clients, and other users of the digital certificate infrastructure to have a more efficient system and method for renewing and revoking certificates, which overcomes at least in part the inefficiencies and shortcomings of currently available renewal and revocation approaches and technologies.

### SUMMARY OF THE INVENTION

This invention addresses, alleviates, and solves, at least in part, these problems and shortcomings by updating certificate fields on a server before a certificate expires.

This invention improves upon previous approaches to the renewal/revocation problems described herein Like short term certificates, this invention updates a certificate's Validity field. Unlike short term certificates, however, this invention does not require a server administrator to re-install a certificate. Like OCSP stapling, this invention requires the server to request a message from the CA to prove that its organization is in good standing. Unlike OCSP stapling, however, this invention does not require a client to do any more than it already does in checking the Validity field.

Under the invention disclosed herein, a digital certificate may contain a renewal extension field through which any number of additional fields may be added to the certificate. When a certificate is installed on a server, the CA may provide, as an additional field in the certificate's extension field, an encrypted field with renewal or revocation information. This field is referred to herein as a “renewal field.” This encrypted field may contain one or more layers of renewal/revocation information. Each layer of revocation/renewal information may comprise several fields, including but not limited to, Validity, CA Renewal Request Location Extension, Certificate Signature Value, and an encrypted field comprising the next encrypted layer(s) of renewal/revocation information. Each layer of renewal/revocation information may be encrypted with a unique symmetric key and may provide a new set of renewal/revocation fields as described above.

With this invention, before a certificate expires, a server for which the certificate was issued, or an administrator for the server, or some other party having need, interest, and/or authority to renew the certificate, may contact the issuing CA to request a symmetric key to decrypt the next layer of renewal/revocation information in the certificate's extension field. The server may also request additional fields. The CA may respond by providing the requested symmetric key. The server may then use the symmetric key to decrypt the next embedded extension layer containing the fields and other information described above. The server may then replace the certificate's fields with these decrypted fields. With these updated fields, the certificate may be renewed and become valid again for another extension of time.

Because this invention requires only a symmetric key to decrypt the next layer of renewal extension, this renewal process can be performed easily by an administrator or automatically by the server. This invention also makes it possible to renew a certificate without reinstalling it. This invention also enables a CA to easily revoke a certificate—by refusing to supply the symmetric key for the next layer of the extension after the certificate has expired.

Further efficiencies are achieved because clients are not required to perform any extra or explicit checking to determine if a certificate is revoked. This saves client resources, including the transceiver power and network bandwidth used during the TLS handshake and revocation check.

By allowing a certificate to be automatically renewed, this invention may help to avoid service outages and other undesirable consequences that may result from a certificate expiring with a server administrator's knowledge. A server could be automatically given an extra time period, e.g., a week, to retrieve and install a new certificate without experiencing a service outage or other undesirable result.

This invention further allows servers and server administrators to securely and automatically update their installed certificates by requesting a symmetric key from a CA for the next renewal extension layer in a particular certificate, and then using the received symmetric key to decrypt updated certificate fields in the certificate's next renewal extension layer.

Further, when a server's private keys are compromised, this invention makes it possible to revoke a certificate within a short period without forcing clients (e.g., Internet browsers) to check with the CA to determine the certificate's revocation status. Instead, a CA may revoke a certificate by simply not providing a symmetric key in response to a server's request for a symmetric key for the next renewal extension layer in the certificate. When the certificate expires and the server is unable to obtain a symmetric key to decrypt the next renewal extension layer in the server, then the expiration date on the certificate will indicate to a client that the certificate is expired. This invention thereby provides a server-only revocation scheme for online and offline servers, mitigating the risk of compromised private keys.

This invention further provides a method and system to update other certificate fields at regular intervals by including multiple encrypted and embedded extension fields with customized or regularly occurring expiration dates, whereby each additional embedded and encrypted field in the renewal extension includes a new value for the field to be updated according to a regular schedule or according to the expiration dates in the certificate and the embedded and encrypted extension fields. This can be useful, for example, for short-term certificates, which may require regular updates of the Subject Public Key Info field, or any other field known in the art.

In one embodiment, one or more renewal extension layers may be embedded recursively.

### BRIEF DESCRIPTION OF THE DRAWINGS

FIG. 1 is a diagram of an exemplary embodiment of a method for certificate renewal and/or revocation.

FIGS. 2A, 2B, 2C, and 2D illustrate exemplary certificate structures for recursively embedding and embedding zero, one, two, and three, respectively, extension layers in a certificate.

FIG. 3 illustrates an exemplary system embodiment of the certificate renewal and/or revocation invention disclosed herein.

### DETAILED DESCRIPTION OF THE INVENTION

This invention is a method and system for renewing and revoking digital certificates, or for updating information and/or fields in a digital certificate. Several exemplary embodiments are described herein.

Each of the components described herein may refer to a software package, virtual appliance, hardware system, or other apparatus or process that can perform the described function. Although described as separate components or systems, the components could be combined in various ways and still remain within the scope of the invention.

In at least some embodiments, all communication between a CA and a server is encrypted to prevent man-in-the-middle attacks.

The following description references a CA as the entity that may receive and/or respond to a request from a server for a symmetric key for the next, or another, layer of the renewal extension. This reference to a CA is exemplary and not exhaustive. The CA could be replaced by any service or entity that may receive a request for a symmetric key for a layer of the renewal extension, and which may provide the symmetric key for the next layer of the renewal extension in response to such request. The server, as described and referenced herein, could refer to or be replaced by any entity, including a client, requiring an updated certificate or information about updated or revoked certificates. The terms “CA” and “server,” as used herein, are therefore exemplary, and not limiting.

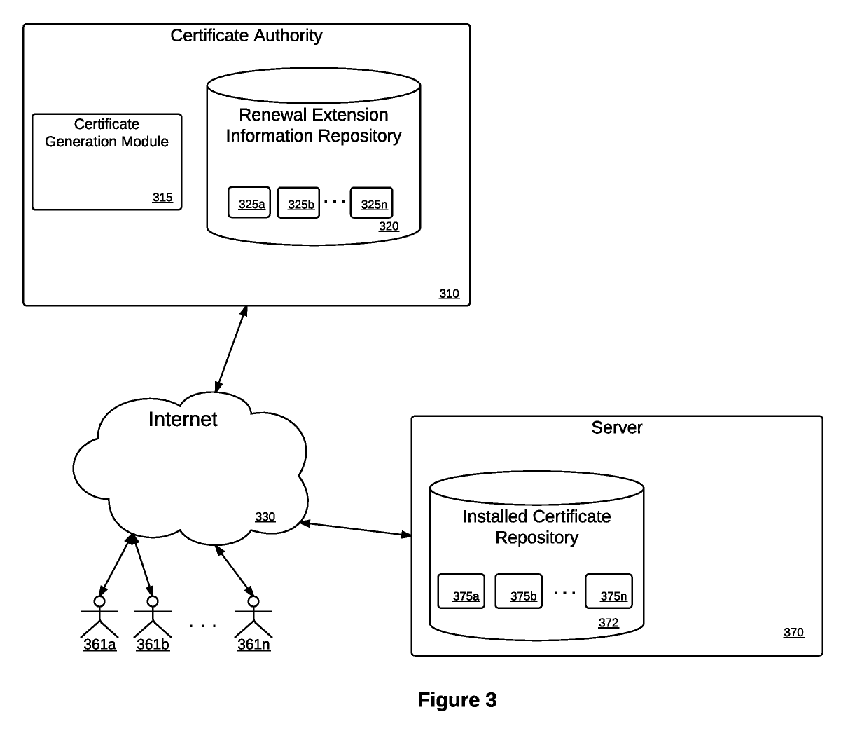

The following description makes references to the system components, modules, items, networks, and other elements in FIG. 3. A person of ordinary skill will appreciate that the elements in FIG. 3 are exemplary, and that many variations are within the scope of this disclosure and invention. For example, components could be software, hardware, or any other configuration within the grasp of a person of skill.

Referring now to FIG. 3, Certificate Authority (“CA”) 310 may be any type of CA or other entity that issues certificates or that generates, maintains, and/or provides renewal extension information, such as symmetric keys, as will be described herein below. CA 310 may include a Certificate Generation Module 315 for generating or preparing certificates. In an alternate embodiment, Certificate Generation Module 315 may not necessarily be a part of CA 310, but may communicate with CA 310 or function in conjunction with CA 310 to generate and/or provide certificates to one or more servers or other entities.

CA 310 may also include, control, maintain, or communicate with Renewal Extension Information Repository 320, which may store and/or generate renewal extension information 325a-n, wherein each set of renewal extension information may be associated with one or more certificates. As described herein below, renewal extension information 325a-n may include a symmetric key and other information. If not a part of CA 310, Renewal Extension Information Repository 320 may communicate with CA over the Internet or via any other networking or communication technology known in the art. In some embodiments, Renewal Extension Information Repository may communicate directly with one or more servers, without going through CA 310.

Network 330 may be the Internet or any other network infrastructure and/or technology known in the art. Internet Users 361a-n may be web browsers, computers, or other devices with networking technology, or any other device or technology that may rely on digital certificates or the digital certificate infrastructure.

Server 370 may be any server or other device that may request, receive, install, and/or use one or more digital certificates from CA 310. Server 370 may communicate with Internet Users 316a-n and CA 310, and other components in FIG. 3, via Internet 330 or via any other networking infrastructure or technology known in the art. Server 370 may include, or be connected to, or communicate with, or associated with Installed Certificate Repository 372. Installed Certificate Repository 372 may contain one or more issued and installed certificates 371a-n. As described herein below, each certificate 375n may include one or more renewal extensions, and may be updatable and/or revocable using the invention described herein.

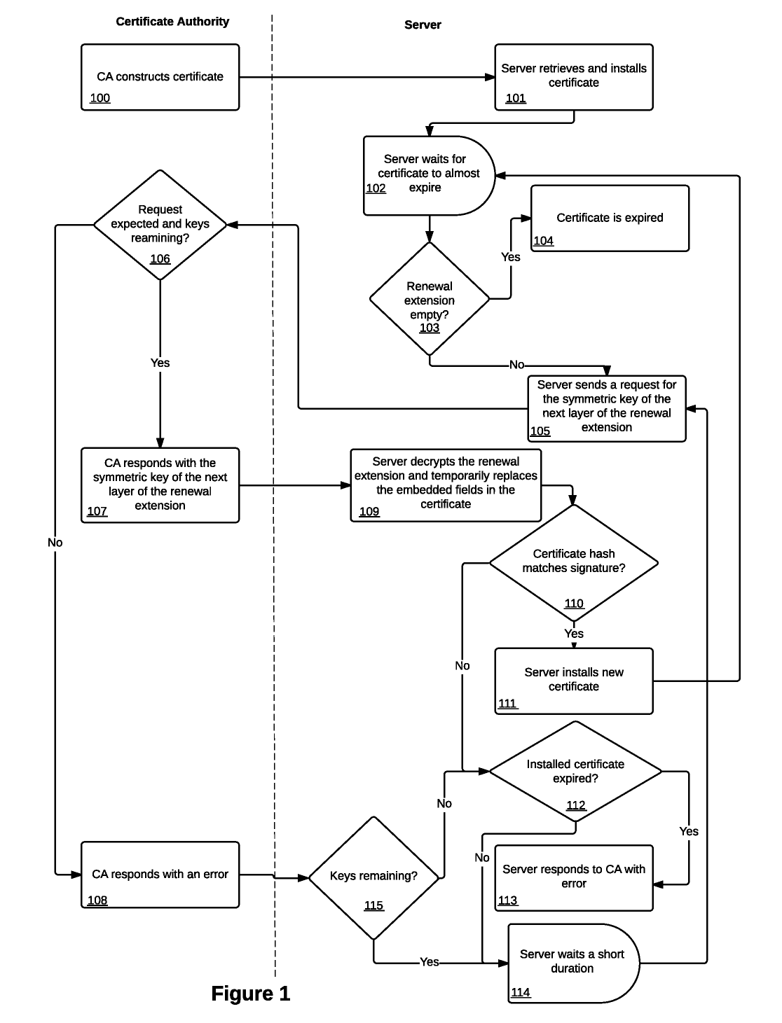

Referring now to FIG. 1, at step 100 CA 310 may construct a certificate. The certificate may be constructed according to X.509 and may include, in an extension, the CA Renewal Request Location and renewal extension. The X.509 digital certificate standard allows for and defines a structure for such extensions, by which a CA may define its own extensions within the time-based-security (TBS) certificate without any need to modify or append to the existing X.509 standard.

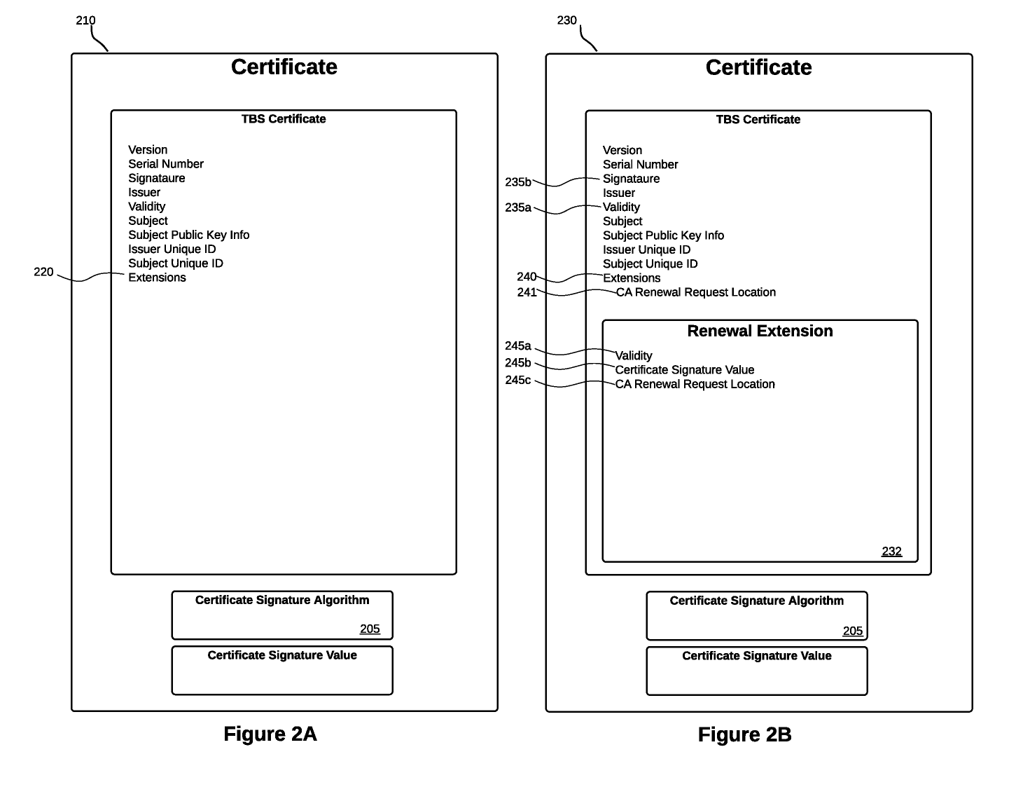

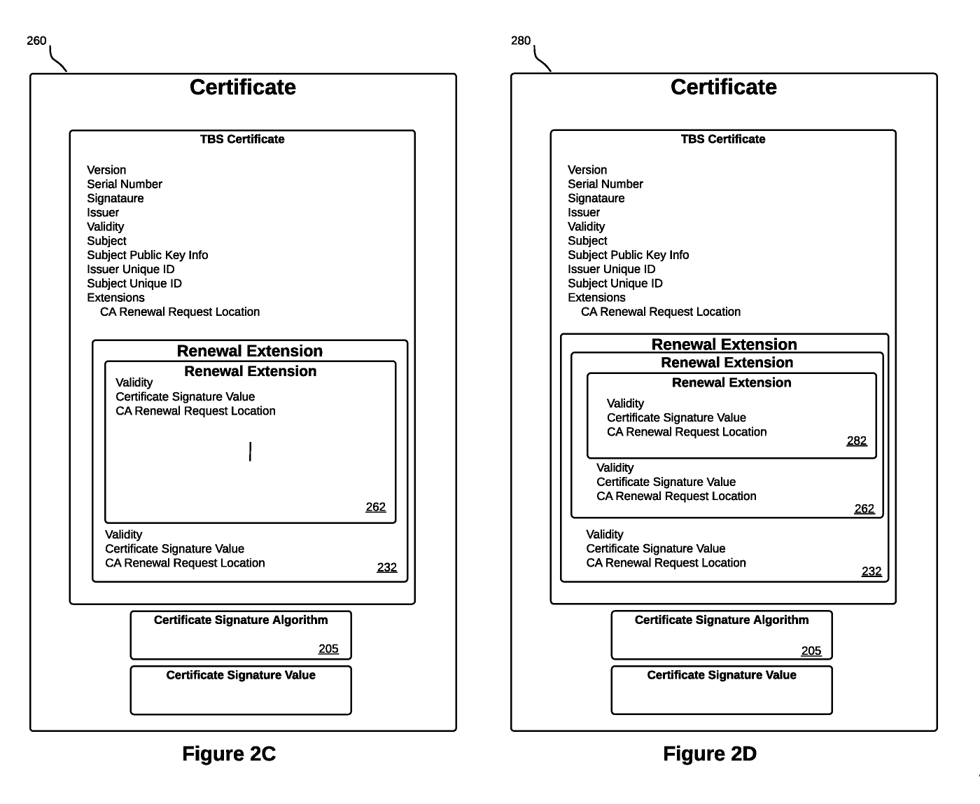

FIGS. 2A-2D show multiple exemplary certificates 210, 230, 260, and 280 with varying levels of recursive renewal extension embedding.

Exemplary certificate 210 in FIG. 2A shows a certificate with zero layers of embedded extensions. Extensions structure 220 is empty because the certificate does not include any extensions. Even if a certificate does not include any encrypted extension layers for revocation or renewal as disclosed in this invention, the certificate may still include other fields and/or information in its extension structure. FIGS. 2A-2D do not illustrate other possible extension fields because the focus of this invention is encrypted renewal extension layers.

Certificates 230 (FIG. 2B), 260 (FIG. 2C), and 280 (FIG. 2D) have one, two, and three, respectively, levels of recursively embedded renewal extensions. The CA may construct certificates 230, 260, and 280 by placing a Validity, CA Renewal Request Location extension, and Certificate Signature Value field into the renewal extension, along with respective field names and values, and the CA may encrypt these fields with a unique symmetric key. The CA may also place one or more other fields into the renewal extension, such as, for example, an Issuer field, or any other field as may be determined by a person of ordinary skill.

For example, certificate 230 in FIG. 2B has one embedded renewal extension 232 comprising fields Validity 245a, Certificate Signature Value 245b, and CA Renewal Request Location 245c. Exemplary certificate 260 in FIG. 2C has two layers of recursively embedded renewal extensions 232 and 262. Each of renewal extension layers 232 and 262 may comprise fields similar to those shown in renewal extension layer 232 in FIG. 2B. As depicted in FIG. 2C, renewal extension layer 262 may be recursively embedded in renewal extension layer 232.

Exemplary certificate 280 in Figure D has three layers of recursively embedded renewal extensions 232, 262, and 282. Each of renewal extension layers 232, 262, and 282 may comprise fields similar to those shown in renewal extension layer 232 in FIG. 2B. As depicted in FIG. 2D, renewal extension layer 282 may be recursively embedded in renewal extension layer 262, and renewal extension layer 262 may be recursively embedded in renewal extension layer 232.

Each layer of renewal extension is encrypted with a different symmetric key. For example, certificate 280 includes three layers of recursively embedded renewal extensions: 232, 262, and 282. Renewal extension 282 is embedded within renewal extension 262, which is embedded within renewal extension 232. The symmetric keys for renewal extensions 232, 262, and 282 may all be distinct from each other, so that the symmetric key for renewal extension 232 decrypts the fields in renewal extension 232, but does not decrypt the fields in renewal extensions 262 and 282, and the symmetric key for renewal extension 262 decrypts the fields in renewal extension 262 but not in 282, and the symmetric key for renewal extension 282 decrypts the fields in renewal extension 282.

At step 101, server 370, or server 370's administrator, may retrieve the constructed certificate from CA 310 and may install it on server 370. At step 102, server 370 may wait for a predetermined time before the certificate expires. This time may be negotiated between CA 310 and server 370 or server 370's administrator beforehand. In one embodiment, the predetermined time may be within one week before the certificate's expiration. Server 370 may wait, however, any amount of time which may be determined for many varying reasons, and may optionally go to step 103 manually, without necessarily waiting for any specific time period to pass or expire.

At step 103, server 370 may determine whether the renewal extension is empty. For example, certificate 210 in FIG. 2A depicts an exemplary empty renewal extension: extensions structure 220 does not have any renewal extension. If the renewal extension is empty and the certificate is expired, the process ends at terminal step 104. Otherwise, at step 105 server 370 may use the location in the CA Renewal Request Location extension to request, from CA 310, the symmetric key that was used to encrypt the renewal extension. For example, as shown in FIG. 2B, a server may use CA Renewal Request Location 241 to request a symmetric key to decrypt renewal extension 232.

The CA Renewal Request Location is typically a URL to a CA, but can also be a file location, network address, or any other location of a service for responding to a request for a symmetric key to decrypt a renewal extension. Server 370 will typically request only the symmetric key for the next renewal extension layer. However, it may optionally request additional fields to be updated, such as the certificate's public key or the Subject field data.

At step 106, CA 310 may determine if the request for the key is within the expected time frame, which may be about a week before the certificate's expiration, or may be some other time period. If the request is in the expected time frame, then CA 310 may, at step 107, respond by providing the symmetric key for the next layer of renewal extension if symmetric keys remain. CA 310's response may also include the additional fields requested by server 370 at step 105. If CA 310 responds with the symmetric key or additional fields, it may also provide to server 370 a new signature for the certificate to replace the existing signature in the next renewal extension layer. If the request is not expected or there are no symmetric keys remaining, CA 310 may respond to the server 370 with an error message describing the issue and the process may terminate at step 108.

If CA 310 indicates that an error occurred because a request was outside of the expected date range, then server 370 may determine at step 115 whether there are still encrypted renewal extensions for which it needs a symmetric key. If there are, then at step 114 server 370 may wait for some duration before again attempting to request the next layer of the renewal extension at step 105. If the error indicates that there are no more symmetric keys, then server 370 may determine at step 112 that the certificate is expired.

If CA 310 responds at step 107 with the symmetric key of the next layer of renewal extension, then server 370, at step 109, may use the provided symmetric key to decrypt the next layer of renewal extension, and may replace the values in the certificate with the newly decrypted values from the next layer of renewal extension, which may include Validity, CA Renewal Request Location, Certificate Signature Value, the new renewal extension, and any other embedded field. The server may also replace any additional field sent by CA 310 in step 107, including a new signature if provided. For example, as shown in FIG. 2B, upon decrypting fields Validity 245a, Certificate Signature Value 245b, and CA Renewal Request Location 245c, server 370 may replace fields 235a, 235b, and 241, respectively.

As a check, at step 110 server 370 may hash the certificate with the new fields and compare it with the hash contained in the new Certificate Signature Value field. Any secure hashing algorithm can be utilized for this check. If there is a match, server 370 may install the new certificate fields at step 111. If not, server 370 may determine if the old Validity field in the certificate has expired at step 112. If so, server 370 may, at step 113, respond to CA 310 with an error, indicating that the server is unable to renew the certificate and the installed certificate is expired. If the old Validity field in the certificate has not expired, server 370 may wait for some duration at step 114, which may be predetermined by server 370 or server administrator, or set in any other well-known manner, and may return to step 105. This process may be repeated until either the certificate expires (step 112) before an appropriate key can be retrieved from CA 310 for the renewal extension, or until no more renewal extension layers remain (step 104).

For example, if a certificate had an expiration of Jan. 1, 2016, CA 310 may expect server 370 to request a symmetric key for an renewal extension within one week prior to the expiration date, i.e., after the start of the day on Dec. 25, 2015. If CA 310 determines, at step 106, that it received the request after the start of the day on Dec. 25, 2015, then it may, at step 107, send the symmetric key for the next renewal extension layer to server 370. If CA 310 determines at step 106 that the request was received before Dec. 25, 2015, or that no symmetric keys remain for the certificate that is the subject of the request, then CA 310 may, at step 108, respond to server 370 with a descriptive error message. If the error message indicates that the request was made outside of the expected date range, but that more renewal extension layer keys remain, then server 370 may wait at step 114 before re-requesting the symmetric key for the next renewal extension layer.

In one embodiment, this process may be performed offline by simply having a server administrator, or alternate entity or system, perform step 105 using the Location in the CA Renewal Request Location. The server administrator, or alternate entity or system, would then retrieve the key and provide it to the server for continued processing at step 109. In this embodiment, all other steps may be performed as otherwise described herein.

Other certificate fields may also be updated. For example, short-term certificates require replacement of the public and private keys on the server at regular intervals. When constructing the certificate, CA 310 may copy the new Subject Public Key Info field keys and values into some of the renewal extension. Each time it does this, the Public Key Info field contains another unique value provided beforehand by a server or server administrator. If, upon being decrypted at step 109, the renewal extension includes the Subject Public Key Info field, server 370 replaces the field in the current certificate with this new value. Any certificate field may be updated in this manner, i.e., by replacing the embedded fields each time a renewal extension layer is decrypted.

In another embodiment, server 370 may update additional fields by including, in step 105, a request for updated values for the additional fields. For example, in the context of short-term certificates, server 370 may request a new Subject Public Key Info field, and provide a new public key with the request. Upon receiving the updated value for the field, server 370 may replace the old public key in the certificate with the new one.

In another exemplary embodiment, to facilitate performance of the steps described herein, CA 310 may embed an encrypted executable script with the certificate. FIGS. 2A, 2B, 2C, and 2D each depict, in certificates 210, 230, 260, and 280, respectively, a Certificate Signature Algorithm 205 comprising an executable script. This executable script may be encrypted with server 370's public key so that it can be configured confidentially and securely for the server. The server may execute the script in Certificate Signature Algorithm 205 after step 102. Executing the script may result in performing some or all other aspects of this invention as described herein, including but not limited to installing the updated certificate fields. Executing the script may also result in generating the new field values that may be requested at step 105. For example, in the context of short-term certificates, the script may generate a public/private RSA key pair, sending the new public key in the request.

In another embodiment, the invention disclosed herein may be used to revoke root and intermediate certificates. These root and intermediate certificates may be given shortened lifespans, e.g., expiration within only one or two years, or any other lifespan which may be appropriate for a particular set of circumstances. Within some predetermined period before the certificate expires, server 370 may contact CA 310 or a group of CAs for the key for the next encrypted extension layer. CA 310 or the group of CAs may effectively revoke the certificate by not responding to these renewal requests.

A person of ordinary skill will appreciate that many variants of the invention disclosed herein are obvious, well-known, and/or within his or her grasp.

What is claimed is:

1. A method for managing a certificate, comprising:
providing a certificate with an extension field, wherein
the extension field comprises renewal information and
the extension field is secured.

2. The method of claim 1, wherein the extension field is secured through encryption.

3. The method of claim 1, wherein the renewal information comprises multiple sets of renewal information.

4. The method of claim 3, wherein the multiple sets of renewal information are recursively embedded.

5. The method of claim 1, wherein the renewal information comprises at least one of a validity field, a CA renewal request location field, and a certificate signature value field.

6. The method of claim 2, wherein the extension is secured through encryption using a unique symmetric key.

7. The method of claim 3, wherein the multiple sets of renewal information are each encrypted with a unique symmetric key.

8. The method of claim 7, wherein the multiple sets of renewal information are recursively embedded.

9. The method of claim 2, further comprising
receiving a request for a symmetric key to decrypt the extension field,
determining that the request for a symmetric key is valid, and
providing the requested symmetric key.

10. The method of claim 9, wherein determining that the request for a symmetric key is valid comprises determining that the request for a symmetric key is within an expected request time frame.

11. The method of claim 9, further comprising providing at least one additional update field.

12. A method for managing a certificate, comprising:
determining that a certificate has an extension field comprising secured renewal information;
requesting a key for accessing the secured renewal information.

13. The method of claim 12, wherein the extension field is secured through encryption.

14. The method of claim 12, wherein the renewal information comprises multiple sets of renewal information.

15. The method of claim 14, wherein the multiple sets of renewal information are recursively embedded.

16. The method of claim 12, wherein the renewal information comprises at least one of a validity field, a CA renewal request location field, and a certificate signature value field.

17. The method of claim 13, wherein the extension is secured through encryption using a unique symmetric key.

18. The method of claim 14, wherein the multiple sets of renewal information are each encrypted with a unique symmetric key.

19. The method of claim 18, wherein the multiple sets of renewal information are recursively embedded.

20. The method of claim 13, further comprising:
receiving a key in response to the requesting a key;
using the key to access the secured renewal information;
and using the secured renewal information to update one or more fields in the certificate.

21. The method of claim 12, further comprising:
determining that a key has not been provided, within a maximum time period, in response to the requesting a key and
re-requesting the key after waiting until a waiting time period has elapsed.

22. The method of claim 12, further comprising determining that the certificate will expire before a renewal time period has elapsed.

23. The method of claim 20, further comprising:
hashing the fields of the certificate with the updated fields to generate a hash result;
comparing the hash result with a certificate signature value field; and
determining that the hash result matches the certificate signature value field.

24. A certificate management system, comprising:
a certificate generation module configured to provide a certificate with an extension field, wherein
the extension field comprises renewal information and
the extension field is secured.

25. The system of claim 24, wherein the extension field is secured through encryption.

26. The system of claim 24, wherein the renewal information comprises multiple sets of renewal information.

27. The system of claim 26, wherein the multiple sets of renewal information are recursively embedded.

28. The system of claim 24, wherein the renewal information comprises at least one of a validity field, a CA renewal request location field, and a certificate signature value field.

29. The system of claim 25, wherein the extension is secured through encryption using a unique symmetric key.

30. The system of claim 26, wherein the multiple sets of renewal information are each encrypted with a unique symmetric key.

31. The system of claim 30, wherein the multiple sets of renewal information are recursively embedded.

32. The system of claim 25, further comprising a request processing module configured to
receive a request for a symmetric key to decrypt the extension field,
determine that the request for a symmetric key is valid, and
provide the requested symmetric key.

33. The system of claim 32, wherein determining that the request for a symmetric key is valid comprises determining that the request for a symmetric key is within an expected request time frame.

34. The system of claim 32, wherein the request processing module is further configured provide at least one additional update field.
